(19) United States
(12) Patent Application Publication
(10) Pub. No.: US 2015/0083829 A1
(43) Pub. Date: Mar. 26, 2015

(54) Wear-Optimised Production of Conical Injection Holes

(71) Applicant: Heinrich Werger, Kuchl (AT)

(72) Inventor: Heinrich Werger, Kuchl (AT)

(73) Assignee: Robert Bosch GmbH, Stuttgart (DE)

(21) Appl. No.: 14/342,934

(22) PCT Filed: Aug. 28, 2012
(86) PCT No.: PCT/AT2012/000223

§ 371 Date: Jun. 6, 2014

(30) Foreign Application Priority Data
Sep. 6, 2011 (AT) A 1269/2011

(51) Int. Cl. F02M 61/16; F02M 61/18

(52) U.S. Cl. CPC F02M 61/168; F02M 61/18; F02M 2200/8069
USPC 239/589; 29/890.132

(57) ABSTRACT

A method for producing injection holes in fuel injection nozzles for internal combustion engines. An injection hole is formed by at least one abrading manufacturing method. An injection nozzle is subsequently subjected to a hardening treatment at least in the region of the injection hole, such that the injection hole surface is hardened over the entire axial length thereof.

The invention relates to a method for producing spray holes in fuel injection nozzles for internal combustion engines, in which method at least one manufacturing step for forming the spray hole and at least one hardening step are performed.

The invention also relates to a fuel injection nozzle for internal combustion engines, which fuel injection nozzle has at least one spray hole.

Fuel injection nozzles are composed of the nozzle body and the nozzle needle, which are both produced from high-grade steel. The nozzle needle is arranged in an axially displaceable manner in the nozzle body and has a conical valve sealing surface on its combustion-chamber-side end. By means of said conical valve sealing surface, the nozzle needle interacts with a conical valve seat surface arranged at a closed end of a bore in the nozzle body, wherein a sealing cross section is formed at the contact line between valve sealing surface and valve seat surface. Said sealing cross section is followed, in the downstream direction as viewed in the fuel flow direction, by spray holes which are arranged in the wall of the nozzle body and which, proceeding from the bore in the nozzle body, open out on the outer shell surface of said nozzle body and, in so doing, project into the combustion chamber of the internal combustion engine which is to be supplied with fuel. Here, said spray holes may for example be of conical form, wherein the cross section of the spray holes decreases in a uniformly conical manner from a relatively large diameter at the fuel inlet to a relatively small diameter at the fuel outlet.

Hole-type nozzles as described above are used in direct-injection diesel engines, in particular in common rail systems, where they spray the fuel, which is at very high pressure, onto the walls of the opposite piston depression in a focused injection jet. The nozzle body generally has multiple spray holes which, in the interior of the nozzle, form a uniform hole circle on the shell of a cone. Depending on the engine, the number of spray holes is between 5 (in the case of passenger motor vehicles) and 14 (in the case of large diesel engines). The hole diameter varies between 0.15 mm (in the case of passenger motor vehicles) and 0.4 mm (in the case of heavy goods vehicles). The number of spray holes, the spray hole angle and the spray hole size and also the flow conditions at the nozzle holes influence the injection jet and the atomization thereof. The combustion quality during the combustion of the diesel fuel is determined by the respective spray pattern together with other factors such as, for example, the injection flow rate, the injection pressure, the pressure profile, the combustion chamber geometry, the compression pressure and the compression temperature.

The spray holes are subject to very high mechanical loads. The action of wear mechanisms such as, for example, cavitation or particle erosion can lead to rapid advancement of wear and thus to changes in the injection jet form, the jet propagation and also the mass throughput. Said changes can lead not only to the exceedance of legal emissions limits but indeed also to engine damage and thus failure. To impede such consequential damage, the injection nozzles have to be exchanged, and replaced with new ones, after a relatively short running time.

There are various methods for forming the spray holes into injection nozzles. For example, the spray holes may be produced by means of drilling or punching. The form of spray holes produced in this way is approximately cylindrical, corresponding to the form of the drilling or punching tool.

It is also known for the spray holes to be produced by means of material-removing manufacturing processes such as, for example, erosion or laser machining. Said manufacturing processes make it possible for the spray holes to be provided with various geometries such as, for example, spray holes of conical design, which normally decrease in diameter in the throughflow direction. A great many other geometries are however known.

It is basically known for the semifinished injection nozzle body to be subjected to a heat treatment process in order to increase wear resistance, strength and the like. Said heat treatment is normally case hardening or nitriding, that is to say heat treatment processes which make the material hard and wear-resistant at the surface but leave the material core relatively soft but also ductile. The spray hole bores extending through the material core therefore often exhibit inadequate wear prevention characteristics in particular in the central region thereof.

The present invention therefore has the aim of increasing the wear resistance of spray holes and thus lengthening the running time of the injection nozzles. At the same time, the configuration of the spray hole geometry should be subject to the least possible restrictions during the production of the spray holes.

To achieve said object, according to a first aspect of the invention, it is substantially provided that, in a method of the type mentioned in the introduction, the spray hole is formed by means of at least one material-removing manufacturing process and that the injection nozzle is subsequently subjected, at least in the region of the spray hole, to a hardening treatment such that the spray hole surface is hardened over its entire axial length. The invention thus relates to the manufacturing procedure during the production of specifically shaped spray holes, that is to say spray holes which are manufactured by means of material-removing manufacturing processes such as, for example, erosion, laser cutting or the like. The essence of the invention now consists in configuring the sequence of the steps of the formation of the hole and of the hardening such that the shaping spray hole production processes, such as for example erosion or laser machining, are performed in each case before the heat treatment responsible for providing the wear prevention characteristics. The spray holes are thus formed in the so-called soft state, and various spray hole geometries, primarily conical geometries, can be produced by means of the material-removing manufacturing processes known per se, and it is nevertheless possible for the wear resistance, strength and corrosion resistance in the spray hole surface to be achieved. Specifically, the hardening treatment is performed only after the formation of the spray hole, such that the spray hole surface can be hardened over its entire axial length.

The heat treatment is preferably performed such that the spray hole surface is hardened uniformly over its entire axial length.

As already mentioned, it is preferably provided that the injection hole is of conical design or comprises a conical region. In particular, the diameter of the spray hole decreases continuously in the throughflow direction.

The injection hole is advantageously produced by erosion or laser machining. A method for the erosion of spray holes is described for example in DE 10360080 A1.

The hardening treatment preferably comprises a surface hardening process. Here, the hardening treatment comprises in particular a nitriding step or a heat treatment step, in particular a case hardening process.

A particularly efficient method implementation provides for the spray hole to be formed in the non-hardened material of the injection nozzle.

The method according to the invention is suitable for the machining of a variety of materials, in particular of steels. The spray hole is preferably formed in an injection nozzle produced by hot isostatic pressing.

According to a second aspect of the invention, a fuel injection nozzle for internal combustion engines is proposed which has at least one spray hole, wherein the spray hole has a non-cylindrical form and the region of the spray hole and the spray hole surface are hardened over their entire axial length.

It is preferable for the spray hole surface to be hardened uniformly over its entire axial length. The injection hole may advantageously be of conical design or comprise a conical region. It is particularly advantageously the case that the diameter of the spray hole continuously increases in the throughflow direction.

The invention will be explained in more detail below on the basis of an exemplary embodiment schematically illustrated in the drawing. In the drawing,

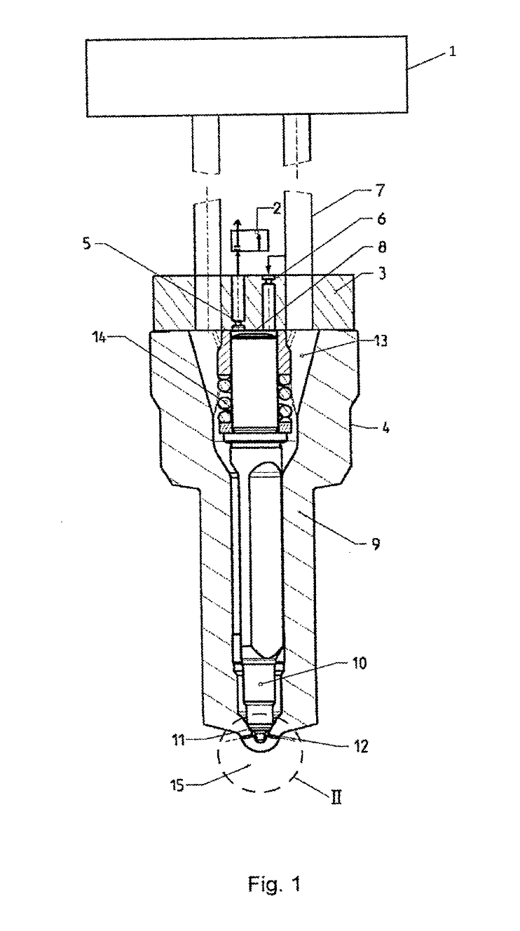

FIG. 1 shows the basic construction of a fuel injection nozzle of a common rail system, and

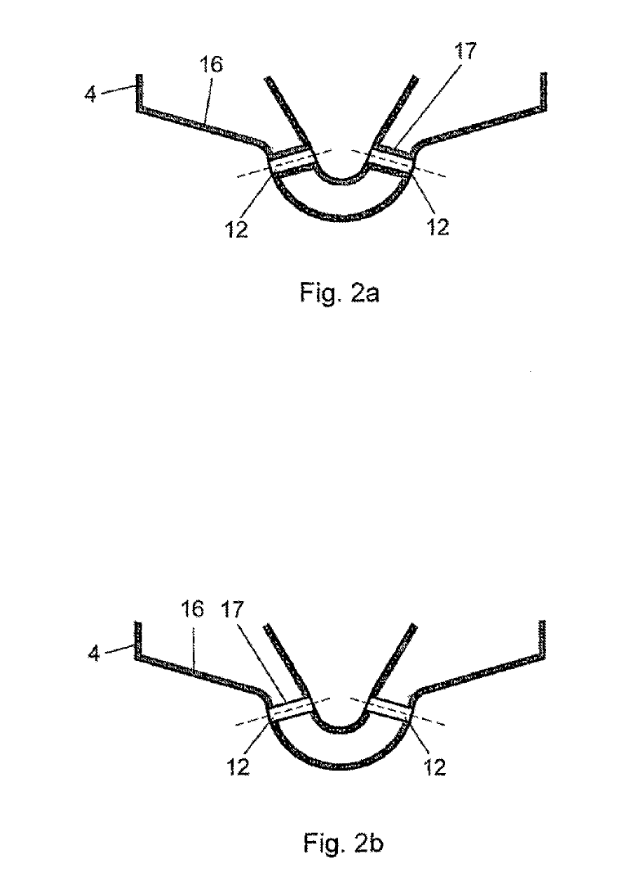

FIG. 2a and FIG. 2b show a detail view of the region II from FIG. 1, wherein FIG. 2a shows a design produced according to the invention, and FIG. 2b shows a design produced in accordance with the prior art.

FIG. 1 schematically shows the construction of a common rail injector composed of a high-pressure accumulator 1, a servo valve 2, a throttle plate 3, and an injection nozzle 4. The servo valve 2, when in the rest state, closes off the outflow throttle 5 provided in the throttle plate 3. As a result, the system pressure prevails in the control chamber 8 which is connected to the accumulator 1 via the high-pressure bore 7 and the inflow throttle 6, such that the nozzle needle 10 is pressed against the nozzle seat 11, which is manufactured in the nozzle body 9, and the spray holes 12 are closed. When the servo valve 2 is actuated, the outflow throttle 5 is opened up, and the fuel situated in the control chamber dissipates its pressure into the low-pressure system (not illustrated). At the same time, there is a follow-up flow of fuel at high pressure via the inflow throttle 6. The effective throughflow cross sections of outflow throttle 5 and inflow throttle 6 are in this case coordinated with one another such that, when the servo valve 2 is actuated, the pressure in the control chamber 8 falls to such an extent that the pressure, acting on the lower part of the nozzle needle 10, in the nozzle chamber 13 pushes the nozzle needle 10 out of the nozzle seat 11 counter to the pressure in the control chamber 8 and counter to the force of the nozzle spring 14, and the spray holes 12 are opened up, such that fuel is injected into the combustion chamber 15. After the closure of the servo valve 2, no more fuel can flow out of the control chamber 8 via the outflow throttle 5, such that the pressure that builds up in said control chamber pushes the nozzle needle 10 into the nozzle seat 11 again.

The spray holes 12 are more clearly shown in the detail views in FIGS. 2a and 2b. For clarity, the nozzle needle is not illustrated. Reference numeral 16 designates a region close to the surface which has been hardened by means of a hardening treatment. The result of a method implementation according to the prior art is shown in FIG. 2b. The injection nozzle 4 has been hardened first, with the spray holes 12 having been formed only thereafter, such that the spray hole surface 17 has not been hardened. By contrast, in the case of the method implementation according to the invention, as illustrated in FIG. 2a, the spray holes are produced first and the hardening treatment is performed thereafter, such that the spray hole surface 17 is also jointly hardened.

1. A method for producing spray holes in fuel injection nozzles for internal combustion engines, comprising:
forming a spray hole in a fuel injection nozzle using at least one material-removing manufacturing process; and
hardening at least a region of the fuel injection nozzle comprising the spray hole with a hardening treatment such that the an entirety of an axial length of a surface of the spray hole is hardened.

2. The method as claimed in claim 1, wherein the entirety of the axial length of the surface of the spray hole is hardened uniformly.

3. The method as claimed in claim 1, wherein the spray hole is defined by a conical shape or comprises a conical region.

4. The method as claimed in claim 3, wherein a diameter of the spray hole continuously decreases in a throughflow direction.

5. The method as claimed in claim 1, wherein forming the spray hole by comprises erosion or laser machining

6. The method as claimed in claim 1, wherein the hardening treatment comprises a surface hardening process.

7. The method as claimed in claim 1, wherein the hardening treatment comprises nitriding or a heat treatment.

8. The method as claimed in claim 1, wherein the spray hole is formed in non-hardened material of the fuel injection nozzle.

9. The method as claimed in claim 1, wherein the fuel injection nozzle is produced by hot isostatic pressing.

10. A fuel injection nozzle for internal combustion engines, comprising:
at least one spray hole, is defined by a non-cylindrical form, wherein an entirety of an axial length of a region of the at least one spray hole and an entirety of an axial length of a surface of the at least one spray hole are hardened.

11. The fuel injection nozzle as claimed in claim 10, wherein the entirety of the axial length of the surface of the at least one spray hole is hardened uniformly.

12. The fuel injection nozzle as claimed in claim 10, wherein the at least one spray hole is defined by a conical shape or comprises a conical region.

13. The fuel injection nozzle as claimed in claim 12, wherein a diameter of the at least one spray hole continuously increases in the throughflow direction.

14. The fuel injection nozzle as claimed in claim 10, wherein the fuel injection nozzle is produced by hot isostatic pressing.
